(19) United States
(12) Patent Application Publication
(10) Pub. No.: US 2014/0237751 A1
(43) Pub. Date: Aug. 28, 2014

(54) DISPERSION-COATED WIPER RUBBER

(71) Applicant: Robert Bosch GmbH, Stuttgart (DE)

(72) Inventors: Nicolaas Gotzen, Kartenberg (BE); Reiner Lay, Aachen (DE)

(21) Appl. No.: 14/192,141

(22) Filed: Feb. 27, 2014

(30) Foreign Application Priority Data
Feb. 27, 2013 (DE) 10 2013 203 194.7

(51) Int. Cl. B60S 1/38

(52) U.S. Cl. CPC B60S 1/38
USPC 15/250.48; 427/427.6

(57) ABSTRACT

A process for the production of a wiper rubber, in particular for a windshield wiper, in which, in a step a), a wiper-rubber base (10) is formed from a natural and/or synthetic rubber, of which (10) at least a portion is coated with a natural- and/or synthetic-rubber dispersion (40) in a step b).

### BACKGROUND OF THE INVENTION

The present invention relates to a process for the production of a wiper rubber, and also to a wiper rubber and a windshield wiper.

Wiper rubbers of windshield wipers serve to ensure good visibility through a windshield in wet conditions.

The publication DE 10 2009 000 072 A1 describes a wiper rubber which has been provided at least to some extent with a powder coating made of a highly precrosslinked natural- and/or synthetic-rubber powder, and also a process for production thereof.

The publication DE 10 2007 034 328 A1 describes a strand extrudate and a process for production thereof. This strand extrudate is composed of an elastomer material on which a coating made of a polymer material has been applied.

### SUMMARY OF THE INVENTION

The present invention provides a process for the production of a wiper rubber, in particular for a wiper blade or for a windshield wiper, for example of a motor vehicle.

The process comprises the steps of:

a) formation of a wiper-rubber base made of a natural and/or synthetic rubber and

b) coating at least of a portion of the wiper-rubber base with a natural- and/or synthetic-rubber dispersion.

The dispersion-coating process has the advantage of being a coating process that protects health and the environment. In particular, when the dispersion-coating process is compared with other coating processes, for example powder coating and melt coating, it can be carried out with less usage of resources for protective measures and therefore also with lower cost. Comparison of the dispersion-coating process with other coating processes, for example powder coating and melt coating, moreover reveals that it can achieve both physical and chemical bonding, and therefore more stable binding of the coating to the wiper-rubber base. The dispersion-coating process is moreover advantageously a coating process amenable to in-line manufacture.

By forming not only the wiper-rubber base but also the coating from a natural and/or synthetic rubber rather than, for example, from another polymer material that is for example chemically incompatible and/or inelastic, it is likewise possible to achieve an advantageous improvement in the stability of binding of the coating on the wiper-rubber base, and to avoid cracking in the coating.

The division of the wiper rubber into wiper-rubber base and coating and, respectively, the multistep, in particular two-step, production thereof also has the advantage that the wiper-rubber base can be formed from a material with properties different from those of the coating. By way of example, it is possible to produce the wiper-rubber base, which requires markedly greater usage of material in comparison with the coating, from a lower-cost material, such as ethylene-propylene-diene rubber (EPDM). For the coating, in contrast, it is also possible to use higher-cost or high-cost materials, for example polymers and fillers such as nanoparticle fillers, in particular in (very) small quantities. Because usage of material for the coating is comparatively small, this method can actually sometimes even reduce total materials costs when higher-cost materials are used in the coating. Division of the wiper rubber into wiper-rubber base and coating also permits optimization of the materials of the sections for their respective function. By way of example, the wiper-rubber base can be formed from a material with good dimensional stability, for example from ethylene-propylene-diene rubber (EPDM), which is also inexpensive, while the material of the coating can, in contrast, be optimized for high abrasion resistance, in particular surface hardness, low coefficient of friction, and/or minimization of running noise, for example running noise caused by friction-induced vibration. By way of example, the material of the coating can be equipped with a higher crosslinking density and, associated therewith, lower flexibility or higher hardness, for example Shore hardness about 90, than the material of the wiper-rubber base, which by way of example can be designed with Shore hardness about 65, in particular without any resultant adverse effect on the overall flexibility of the wiper rubber. As an alternative, or in addition to the above, the material of the coating can comprise fillers designed with a view to optimized friction reduction or wiping-quality improvement and/or noise minimization, while the material of the wiper-rubber base, in contrast, omits specialized and mostly high-cost fillers of this type and can optionally use simpler fillers that are more readily available and/or less expensive. The rubber-dispersion coating moreover advantageously permits omission of a graphite coating, which customarily tends to form water smudges and/or stripes and generally gives only a low level of immediate wiping quality.

For the purposes of one embodiment, the rubber dispersion is a primary dispersion.

The expression primary dispersion can in particular mean a dispersion produced via a polymer-formation reaction, for example via emulsion polymerization or suspension polymerization, directly from monomers, and in particular not via dispersion of a (differently produced) polymer, in particular rubber (secondary dispersion).

A primary dispersion can advantageously have higher chemical reactivity than a secondary dispersion, and this can have an advantageous effect on the stability of binding of the coating on the wiper-rubber base. Furthermore, a primary dispersion can sometimes achieve a more uniform and/or thinner coating. A primary dispersion can moreover exert an exfoliating and/or agglomeration-inhibiting effect (explained in more detail below) on fillers, and this effect can be advantageous for the properties of the coating and therefore of the wiper rubber.

For the purposes of another embodiment, the rubber dispersion comprises at least one filler.

For the purposes of one specific form of the said embodiment, the at least one filler is added before or during a polymer-formation reaction to a reaction mixture for the formation of the primary rubber dispersion. This has the advantage that particularly fine distribution of the filler in the dispersion can be achieved, and agglomeration of filler particles can be avoided. It is thus possible in turn to achieve a particularly uniform coating and/or to improve an effect brought about by the filler on the properties of the coating or of the wiper rubber, in particular on the wiping properties. This is particularly advantageous when nanoparticle fillers are used, since it is possible not only to reduce or indeed avoid agglomeration, which is particularly undesired in the case of nanoparticle fillers, but also sometimes to exert an (additional) exfoliating effect on nanoparticle-filler particles, for example nanotubes and/or phyllosilicates.

The reaction mixture for the formation of the primary rubber dispersion here can in particular comprise a liquid, for example water, monomers and optionally oligomers, and also additives, such as surfactants and/or protective colloids. The polymer-formation reaction here can in particular be initiated through addition of a, for example water-soluble, initiator to the reaction mixture, and the start of the polymerization reaction can thus be controlled as desired—and by way of example adjusted to a juncture after or during the addition of filler.

For the purposes of another embodiment, the at least one filler is selected from the group consisting of nanoparticle fillers, polyethylene particles, in particular particles made of ultra-high-molecular-weight polyethylene (UHMWPE particles) and/or particles made of high-density polyethylene (HDPE particles), polytetrafluoroethylene particles (PTFE particles) and mixtures thereof. These comparatively expensive fillers can improve the properties of the coating or of the wiper rubber, in particular the wiping quality and/or the wiping behavior, for example in respect of minimization of running noise. Use of these in the coating dispersion here permits use of small quantities of materials and thus minimization of total materials costs.

The expression nanoparticle filler can in particular mean a filler which, at least when used as filler within a polymer matrix, is present at least in essence in the form of nanoparticle. In particular, the expression nanoparticle filler can mean either a filler which, even before introduction into the polymer matrix, comprises nanoparticles separated from one another or exfoliated nanoparticles, or at least essentially consists thereof, or an exfoliatable filler, the conversion of which into nanoparticles by exfoliation/separation can be delayed until it is within the rubber dispersion.

The expression nanoparticles can mean particles which, at least in one spatial direction, have a size in the nanometer range, in particular smaller than or equal to 1000 nm, for example smaller than or equal to 100 nm, optionally smaller than or equal to 25 nm.

Before introduction into the polymer matrix, a nanoparticle filler, in particular an exfoliatable nanoparticle filler, can optionally also comprise relatively large particles, for example with layer structure, for example with an average particle size smaller than or equal to 20 μm, in particular smaller than or equal to 10 μm. Before introduction into the polymer matrix, particles with a layer structure can by way of example have an average particle size smaller than or equal to 10 μm and, within the layer structure, have layers with layer thicknesses in the nanometer range, for example about 1 nm, which then, on use as filler within the polymer matrix, become separated from one another and form laminar or lamellar nanoparticles.

However, it is equally possible that, even before introduction into the polymer matrix, a nanoparticle filler comprises separated or exfoliated nanoparticles, or at least essentially consists thereof. This can by way of example be the result of an exfoliating pretreatment, for example organic modification.

For the purposes of another embodiment, the at least one filler comprises (at least) a nanoparticle filler selected from the group of the carbon nanoparticle fillers, in particular carbon nanotubes, nanoclays and mixtures thereof. By way of example, the at least one filler can comprise (at least) carbon nanotubes, in particular exfoliated carbon nanotubes, and/or at least one nanoclay, in particular exfoliatable and/or exfoliated nanoclay. These particularly expensive fillers can improve, to a particularly great extent, the properties of the coating or of the wiper rubber, in particular the wiping quality and/or the wiping behavior, for example in respect of minimization of running noise, whereupon use of these in the coating dispersion can bring about not only minimization of materials costs but also—by virtue of the agglomeration-inhibiting and/or exfoliating/separating effect explained above—improvement of the effect achievable by the said fillers.

The expression nanoclay can in particular mean a material which comprises a phyllo-silicate, in particular a mineral phyllosilicate, for example montmorillonite, bentonite, kaolinite, hectorite and/or halloysite, or is composed thereof, and which comprises (exfoliated/separated) nanoparticles and/or can form nanoparticles (is exfoliatable/separatable to give nanoparticles).

Montmorillonite nanoclays can by way of example have aluminum silicate layers with layer thicknesses around about 1 nm, stacked to give a multilayer system of dimension about 10 μm and which on introduction into a polymer matrix separate from one another and form laminar or lamellar nanoparticles with high aspect ratio (nm×μm).

Halloysite nanoclays can, in contrast, take the form of two-layer aluminum silicate nanotubes, for example with an average size of about 15 nm×about 1000 nm.

It is moreover possible to use nanoclays in an organically modified form, for example in order to provide (directly) exfoliated/separated nanoparticles and/or to bring about, or to improve, exfoliation/separation within the polymer matrix.

Bentonite can by way of example be advantageously used in the form of a quaternary alkylammonium bentonite salt as organically modified nanoclay.

For the purposes of another embodiment, the wiper-rubber base is formed in step a) by extrusion, in particular in the form of a wiper-rubber-base strand. Extrusion is advantageously a process amenable to in-line manufacture.

The wiper-rubber base can in particular comprise a wiper lip, a tiltable web and a fastening section. The wiper lip here can in particular have connection by way of the tiltable web to the fastening section. In the ready-to-use wiper rubber, the wiper lip can in particular have two lateral areas and a frontal area. Between the lateral areas and the frontal area here it is in particular possible to form wiping edges.

In principle it is possible, in step a), to form an individual profile or an individual-profile strand in which the wiper lip is directly formed in the ready-to-use form (two lateral areas, a frontal area and two wiping edges).

However, it is preferable that, in step a), the wiper-rubber base is formed in the form of a double profile, in particular double-profile strand. The expression double profile can mean a body which corresponds to the form of two wiper rubbers connected at the subsequent frontal areas of the wiper lips. From a double profile of this type it is possible by separation, for example cutting, in particular in the longitudinal direction of the double profile, to form two individual profiles or individual-profile strands, the wiper-lip-frontal areas of which are formed by the areas of separation or of cutting.

It is preferable that, in step b), the rubber dispersion is applied at least to one region, in particular the region forming the (subsequent) wiping edges, of the lateral areas of the wiper lip (of the individual profile or of the double profile). When the wiper rubber is used, the said regions have a particularly great effect on the wiping quality or wiping properties of the wiper rubber.

In the case of an individual profile, it is also possible, in step b), to coat the frontal area between the two lateral areas of the wiper lip with the rubber dispersion.

Since the separation preferably takes place after step b), and consequently in the case of a double profile during the coating in step b) there are no frontal areas yet available, it is possible in the case of a double profile that there is no coating in particular on the frontal areas of the wiper lips. However, in the case of production by way of a double profile it is also possible without difficulty to coat the lateral-area regions of the wiper lip which subsequently (after separation) form the wiping edges and are in essence responsible for the wiping quality or wiping properties of the wiper rubber. Production by means of double profile can advantageously markedly increase, for example approximately double, the number of wiper-rubber units that can be produced per unit of time.

For the purposes of another embodiment, the coating process in step b) is achieved by spray-application of the rubber dispersion. In particular, step b) can be achieved by means of spray coating. It is thus possible advantageously to achieve a uniform coating in an in-line process.

It is preferable that, on coating with the natural- and/or synthetic-rubber dispersion in step b), the wiper-rubber base is unvulcanized. In particular, the wiper-rubber base can be co-vulcanized and/or crosslinked together with the coating in a step d) that is explained in more detail below. This not only has the advantage of permitting combination of steps and resultant shortening of production time but can also have an advantageous effect on the stability of binding of the coating on the wiper-rubber base and on the evenness of the coating, for example the avoidance of cracking in the coating.

For the purposes of another embodiment, the process also comprises step c): drying of the coated wiper-rubber base. The drying can in particular remove the liquid, for example water, from the rubber-dispersion coating. The drying in step c) can in particular be achieved via a drying process amenable to in-line manufacture, for example by means of infrared radiation.

For the purposes of another embodiment, the process also comprises step d): (co-) vulcanization of the dried, coated wiper-rubber base. It has proved advantageous that, before vulcanization, the coated wiper-rubber base is freed from liquid, or dried, in order to achieve a coating which has maximum uniformity and minimal defects. The vulcanization in step d) can likewise advantageously be achieved in a process amenable to in-line manufacture, for example in a salt bath.

The process can also comprise step e): separation, in particular cutting, of the wiper-rubber base into individual wiper rubbers. The separation in step e) can likewise be achieved in a process amenable to in-line manufacture. After separation, the wiper rubbers are ready for use and can be packed in a step f). Insofar as the wiper-rubber base is formed in step a) in the form of a double profile or double-profile strand, the double profile or the double-profile strand can be separated into individual profiles in step e). This can be achieved by way of example by separation, in particular cutting, along the double profile and optionally perpendicularly with respect to the double-profile strand.

In-line processes can advantageously reduce total production costs.

Since not only steps a) and b) but also steps c), d) and/or e) and optionally f) can be carried out in processes amenable to in-line manufacture, it is possible to produce wiper rubbers at low cost via an in-line process chain which by way of example can be implemented entirely in-line.

For the purposes of another embodiment, the wiper-rubber base is formed in step a) from chloroprene rubber (CR) and/or ethylene-propylene-diene rubber (EPDM).

In particular, the wiper-rubber base can be formed from ethylene-propylene-diene rubber (EPDM). The use of ethylene-propylene-diene rubber can advantageously achieve particularly clear visibility during wiper use. Ethylene-propylene-diene rubber also advantageously has low cost and good dimensional stability.

For the purposes of another embodiment, step b) uses a natural-rubber (NR) dispersion, chloroprene-rubber (CR) dispersion and/or ethylene-propylene-diene-rubber (EPDM) dispersion.

For the purposes of a specific embodiment, the rubber dispersion (or the coating) and the wiper-rubber base are composed of a natural and/or synthetic rubber of the same type, for example EPDM on EPDM or NR on NR. In this way it is advantageously possible to achieve particularly stable binding of the coating on the wiper-rubber base.

For the purposes of another embodiment, the rubber dispersion has a higher proportion of crosslinking agent than the rubber of the wiper-rubber base. In this way it is advantageously possible to achieve a higher degree of crosslinking and therefore higher hardness of the coating, and this can have an advantageous effect inter alia on the abrasion resistance and/or the coefficient of friction of the coating, and therefore on the wiping properties and the wiping quality of the wiper rubber. The desired overall flexibility of the wiper rubber can be provided here via the material of the wiper-rubber base.

In respect of other technical features and advantages of the process of the invention, explicit reference is made here to the explanations provided in the context of the wiper rubber of the invention, and also to the figures and the description of the figures.

The present invention also provides a wiper rubber, more specifically for a windshield wiper, for example of a motor vehicle. The wiper rubber can in particular have been produced by a process of the invention.

The wiper rubber comprises a wiper-rubber base made of a natural and/or synthetic rubber, where the wiper-rubber base has been provided at least to some extent with a natural- and/or synthetic-rubber-dispersion coating.

The dispersion coating here can in particular be composed of a primary rubber dispersion.

For the purposes of one embodiment, the dispersion coating comprises at least one natural and/or synthetic rubber and at least one filler.

The dispersion coating can in particular comprise natural rubber (NR) and/or chloroprene rubber (CR) and/or ethylene-propylene-diene rubber (EPDM).

The at least one filler can in particular be selected from the group consisting of nanoparticle fillers, polyethylene particles, in particular particles made of ultra-high-molecular-weight polyethylene (UHMWPE particles) and/or particles made of high-density polyethylene (HDPE particles), polytetrafluoroethylene particles (PTFE particles) and mixtures thereof.

For the purposes of another embodiment, the at least one filler comprises carbon nanotubes, in particular exfoliated carbon nanotubes and/or at least one nanoclay, in particular exfoliated and/or exfoliatable nanoclay.

For the purposes of another embodiment, the wiper-rubber base is composed of chloroprene rubber (CR) and/or ethylene-propylene-diene rubber (EPDM). In particular, the wiper-rubber base can be composed of ethylene-propylene-diene rubber.

In respect of other technical features and advantages of the wiper rubber of the invention, explicit reference is made here to the explanations provided in the context of the process of the invention, and also to the figures and the description of the figures.

The invention further provides a windshield wiper which comprises a wiper rubber of the invention.

In respect of other technical features and advantages of the windshield wiper of the invention, explicit reference is made here to the explanations provided in the context of the wiper rubber of the invention and the process of the invention, and also to the figures and the description of the figures.

### BRIEF DESCRIPTION OF THE DRAWINGS

Other advantages and advantageous embodiments of the subject matter of the invention are illustrated by the drawings and explained in the description below. It should be noted here that the drawings are merely descriptive and are not intended to restrict the invention in any way.

FIG. 1 is a diagram of a perspective view of one embodiment of a wiper rubber of the invention; and

FIG. 2 is diagrams to illustrate one embodiment of a process of the invention.

### DETAILED DESCRIPTION

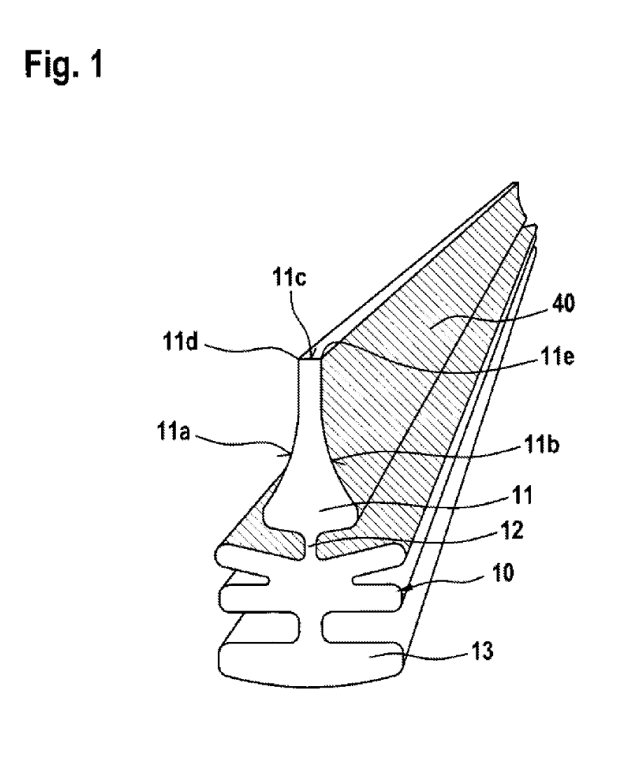

FIG. 1 shows a wiper rubber with a wiper-rubber base 10 made of a natural and/or synthetic rubber. The wiper-rubber base has a wiper lip 11, a tiltable web 12, and a fastening section 13. The wiper lip 11 here has connection by way of the tiltable web 12 to the fastening section 13. The wiper lip 11 has two lateral areas 11a, 1 lb and a frontal area 11c. Between the lateral areas 11a, 1 lb and the frontal area 11c are the wiping edges 11d, 11e.

FIG. 1 shows that the regions of the lateral areas 11a, 11b of the wiper lip 11 which form the wiping edges 11d, 11e have been provided with a natural- and/or synthetic-rubber-dispersion coating 40. The dispersion coating 40 can optionally have a higher degree of crosslinking than the wiper-rubber base 10 and/or can comprise fillers, in particular fillers other than those in the wiper-rubber base 10. By way of example, the dispersion coating 40 can comprise nanoparticle fillers, such as carbon-nanoparticle fillers, for example carbon nanotubes, and/or nanoclays, and/or particles made of ultra-high-molecular-weight polyethylene (UHMWPE particles), and/or polytetrafluoroethylene particles (PTFE particles).

FIG. 1 moreover shows that for the purposes of the embodiment shown therein, the complete lateral areas of the wiper lip 11 and of the tiltable web 12 have been provided with the dispersion coating 40. In the embodiment shown in FIG. 1, the fastening section 13 has moreover also to some extent been provided with the dispersion coating 40. In contrast, the frontal area 11c of the wiper lip 11 is uncoated.

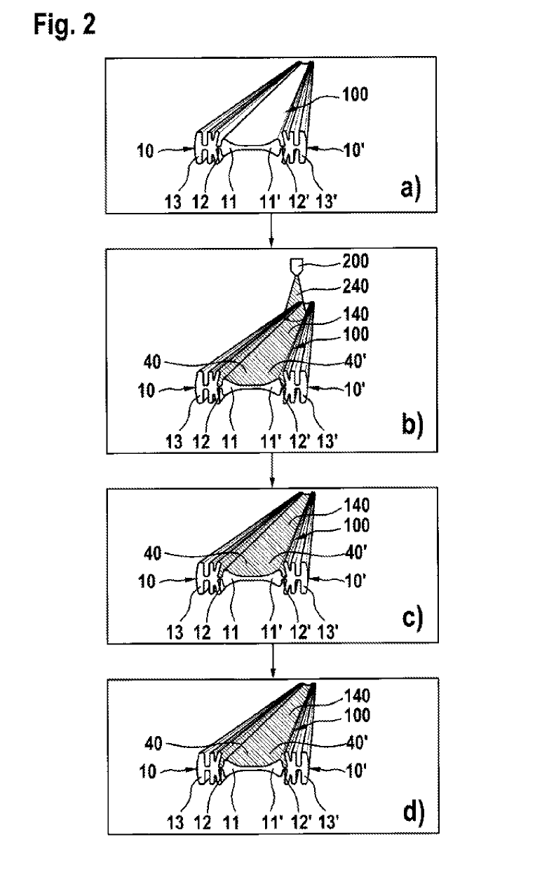

A wiper rubber of this type can be produced by an embodiment of the process of the invention by means of a double profile, as explained in FIG. 2.

FIG. 2 illustrates formation, in a step a), of a wiper-rubber base 10, 10′; 100 in the form of a wiper-rubber-base double-profile strand 10, 10′; 100 by extrusion from a natural and/or synthetic rubber. FIG. 2 shows that the double profile 10, 10′; 100 here takes the form of two wiper rubbers, of which the wiper-rubber base 10, 10′ in each case has a wiper lip 11, 11′, a tiltable web 12, 12′, and a fastening section 13, 13′, and which have connection to one another at the subsequent frontal areas of the wiper lips 11, 11′.

FIG. 2 moreover shows that, in a step b), at least one part 11, 11′, 12, 12′ of the wiper-rubber-base double-profile strand 10, 10′; 100 is coated 40, 40′, 140 with a natural- and/or synthetic-rubber dispersion 240. The rubber dispersion 240 here is spray-applied from nozzles 200 onto the lateral areas of the wiper lips 11, 11′ and of the tiltable webs 12, 12′ and to some extent of the fastening sections 13, 13′ of the wiper-rubber-base double-profile strand 10, 10′; 100; however, 200 in the drawing of FIG. 2 represents only one of these nozzles 200, namely an upper nozzle 200. The nozzles 200 do not have to be arranged as represented in FIG. 2 above and below the wiper-rubber-base double-profile strand 10, 10′; 100: they can also be arranged at the side of the wiper-rubber-base double-profile strand 10, 10′; 100, the orientation of which should however then be vertical rather than horizontal (not shown).

FIG. 2 illustrates that, in a step c), the dispersion-coated wiper-rubber base 10, 10′, 40, 40′; 100, 140 is then dried, for example by means of infrared radiation.

FIG. 2 moreover illustrates that, in a step d), the dried, coated wiper-rubber base 10, 10′, 40, 40′; 100, 140 is subsequently vulcanized by way of example in a salt bath. In particular, the wiper-rubber base 10, 10′; 100 and the dispersion coating 40, 40′; 140 here can be co-vulcanized.

The wiper-rubber-base double-profile strand 10, 10′, 40, 40′; 100, 140 can then, in a further step e) not shown, be separated, in particular cut, into individual wiper rubbers. The separation or cutting process here can be achieved in the longitudinal direction of the double profile to form two individual profile strands, or else across the direction of the strand to give individual wiper rubbers which can then, as shown in FIG. 1, have an uncoated wiper-lip frontal area 11c at the area of separation or of cutting.

What is claimed is:

1. A process for the production of a wiper rubber for a windshield wiper, comprising the steps of:
a) forming a wiper-rubber base (10; 100) made of a natural and/or synthetic rubber; and
b) coating at least of a portion of the wiper-rubber base (10; 100) with a natural- and/or synthetic-rubber dispersion (40; 140).

2. The process according to claim 1, wherein the rubber dispersion (40; 140) is a primary dispersion.

3. The process according to claim 1, wherein the rubber dispersion (40; 140) comprises at least one filler.

4. The process according to claim 3, wherein the at least one filler is added before or during a polymer-formation reaction to a reaction mixture for formation of the primary rubber dispersion.

5. The process according to claim 3, wherein the at least one filler is selected from the group consisting of nanoparticle fillers, polyethylene particles, polytetrafluoroethylene particles and mixtures thereof.

6. The process according to claim 3, wherein the at least one filler comprises a nanoparticle filler selected from the group of the carbon nanoparticle fillers, nanoclays and mixtures thereof.

7. The process according to claim 1, wherein the wiper-rubber base (10; 100) is formed in step a) by extrusion.

8. The process according to claim 1, wherein the coating process in step b) is achieved by spray-application of the rubber dispersion.

9. The process according to claim 1, wherein the wiper-rubber base (10; 100) is formed in step a) from ethylene-propylene-diene rubber and/or chloroprene rubber, and wherein step b) uses an ethylene-propylene-diene-rubber dispersion, chloroprene-rubber dispersion and/or natural-rubber dispersion.

10. The process according to claim 1, wherein the rubber dispersion (40; 140) has a higher proportion of crosslinking agent than the rubber of the wiper-rubber base (10; 100).

11. The process according to claim 1, wherein the process also comprises the steps of:
c) drying the coated wiper-rubber base (10, 40; 100, 140); and
d) vulcanizing the dried, coated wiper-rubber base (10, 40; 100, 140).

12. A wiper rubber for a windshield wiper produced by a process according to claim 1, wherein the wiper-rubber base (10) has been provided at least to some extent with a natural- and/or synthetic-rubber-dispersion coating (40) and wherein the dispersion coating (40) is composed of a primary rubber dispersion.

13. The wiper rubber according to claim 12, wherein the dispersion coating (40) comprises at least one natural and/or synthetic rubber and at least one filler selected from the group consisting of nanoparticle fillers, particles made of ultra-high-molecular-weight polyethylene and/or particles made of high-density polyethylene, polytetrafluoroethylene particles and mixtures thereof, wherein the at least one filler comprises exfoliated carbon nanotubes, and/or at least one exfoliated and/or exfoliatable nanoclay.

14. The wiper rubber according to claim 12, wherein the wiper-rubber base (10) is composed of ethylene-propylene-diene rubber, and wherein the dispersion coating (40) comprises ethylene-propylene-diene rubber and/or chloroprene rubber and/or natural rubber.

15. A windshield wiper comprising a wiper rubber (10, 40) according to claim 1.

16. The process according to claim 3, wherein the at least one filler is selected from the group consisting of nanoparticle fillers, particles made of ultra-high-molecular-weight polyethylene and/or particles made of high-density polyethylene, polytetrafluoroethylene particles and mixtures thereof.

17. The process according to claim 3, wherein the at least one filler comprises a nanoparticle filler selected from the group of carbon nanotubes, nanoclays and mixtures thereof.

18. The process according to claim 1, wherein the wiper-rubber base (10; 100) is formed in step a) by extrusion in the form of a wiper-rubber-base strand.

19. The process according to claim 1, wherein the wiper-rubber base (10; 100) is formed in step a) from ethylene-propylene-diene rubber, and wherein step b) uses an ethylene-propylene-diene-rubber dispersion, chloroprene-rubber dispersion and/or natural-rubber dispersion.

20. The process according to claim 1, wherein the process also comprises the steps of:
c) drying the coated wiper-rubber base (10, 40; 100, 140); and
d) vulcanizing the dried, coated wiper-rubber base (10, 40; 100, 140),
wherein the drying in step c) is achieved via infrared irradiation and wherein the vulcanizing in step d) is achieved in a salt bath.

21. A windshield wiper rubber comprising a wiper-rubber base (10) made of a natural and/or synthetic rubber, wherein the wiper-rubber base (10) has at least to some extent a natural- and/or synthetic-rubber-dispersion coating (40).

22. The wiper rubber according to claim 21, wherein the dispersion coating (40) comprises at least one natural and/or synthetic rubber and at least one filler, polyethylene particles, polytetrafluoroethylene particles and mixtures thereof.

23. The wiper rubber according to claim 21, wherein the wiper-rubber base (10) is composed of ethylene-propylene-diene rubber and/or chloroprene rubber, and wherein the dispersion coating (40) comprises ethylene-propylene-diene rubber and/or chloroprene rubber and/or natural rubber.

24. The wiper rubber according to claim 21, wherein the dispersion coating (40) is composed of a primary rubber dispersion.
